(19) United States
(12) Patent Application Publication
(10) Pub. No.: US 2016/0316175 A1
(43) Pub. Date: Oct. 27, 2016

(54) META-DATA BASED MULTIPARTY VIDEO FRAME POSITION & DISPLAY TECHNOLOGY

(71) Applicant: Minghao Wang, Fremont, CA (US)

(72) Inventor: Minghao Wang, Fremont, CA (US)

(73) Assignee: Minghao Wang, Fremont, CA (US)

(21) Appl. No.: 15/050,864

(22) Filed: Feb. 23, 2016

Related U.S. Application Data
(60) Provisional application No. 62/119,805, filed on Feb. 23, 2015.

(51) Int. Cl. H04N 7/15; H04N 7/14

(52) U.S. Cl. CPC H04N 7/152; H04N 7/147

(57) ABSTRACT

The present invention discloses a networked communication system. The networked communication system comprises a multipoint control unit (MCU) operating a MCU server to receive and process multimedia data transmitted from a plurality of networked communication devices functioning as clients of the MCU. The multimedia data transmitted from each of the clients further include meta-data identifying each of the clients transmitting the multimedia data and the MCU server further processes the multimedia data according to the meta-data to position the multimedia data in a plurality of frames for real-time multiple party display for each of the clients.

### BACKGROUND OF THE INVENTION

1. Field of the Invention

This invention relates generally to networked communication systems. More particularly, this invention relates to novel techniques to manage video conference systems to position and display real-time multi-party video frames by using metadata.

2. Description of the Prior Art

Currently for multiparty video conferencing, there are two approaches. Peer-to-peer approach and MCU Multipoint Control Unit approach. Peer to peer approach is good for clients, such as desktops, with high bandwidth and fast CPU power. MCU approach is used for low bandwidth and slow CPU power clients, such as mobile. In MCU approach, there is a mode called: Continuous Presence, in which multiple parties can be seen on-screen at once. In order to do that, multiple video inputs are mixed at the MCU and streamed as one output to the client. However, each client requires a different way of displaying other parties' images inside the video frame. Thus, MCU side needs to mix and encode frames separately for each individual client. That approach means MCU side CPU load increase by n number of times, where n is the number of client.

The current MCU based solution requires more CPU power or hardware resources on the MCU. It does not require any client side work.

Mobile devices are becoming prevalent as a way of communication, where it has slower CPU power or hardware resources and lower bandwidth. Thus MCU is necessary to allow multi-party video conferencing.

Therefore, a need still exists in the art to provide an improved configuration and procedure for more efficient multiparty video frame positioning and display.

### SUMMARY OF THE PRESENT INVENTION

Therefore, it is an aspect of this invention to provide an improved system configuration with more intelligent video and audio data communications and management between the video conference users and the multipoint control unit (MCU) to save the computing power of the server of the MCU such that the more efficient operation of the video conferencing systems can be achieved.

Furthermore, it is another aspect of this invention to provide an improved system configuration with more intelligent video and audio data communications and management between the video conference users and the multipoint control unit (MCU) to allow a video conference user to have more intelligence and flexibilities to position and display multi-party video images on the device of the video conference user as a client.

Briefly, in a preferred embodiment, the present invention provides a networked communication system, The networked communication system comprises a multipoint control unit (MCU) operating a MCU server to receive and process multimedia data transmitted from a plurality of networked communication devices functioning as clients of the MCU. The multimedia data transmitted from each of the clients further include meta-data identifying each of the clients transmitting the multimedia data and the MCU server further processes the multimedia data according to the meta-data to position the multimedia data in a plurality of frames for real-time multiple party display for each of the clients. In a specific embodiment, the multimedia data, generates a new meta-data of the position and characteristics of each client inside the mixed video image, transmits both the newly generated meta-data and all of the clients' input meta-data back to those clients to allow them to position the multimedia data in a plurality of frames for real-time multiple party display.

These and other objects and advantages of the present invention will no doubt become obvious to those of ordinary skill in the art after having read the following detailed description of the preferred embodiment which is illustrated in the various drawing figures.

### BRIEF DESCRIPTION OF THE DRAWINGS

FIG. 1 is a system diagram for illustrating a networked communication system to carry out a multipoint multimedia communication of this invention.

FIGS. 2A and 2B show the video data repositions and superimposes carried out by the networked communication system.

FIGS. 3A to 3C are flowcharts to show the processes carried out by the client's device and the MCU server according to an embodiment of the present invention.

### DETAILED DESCRIPTION OF THE PREFERRED EMBODIMENT

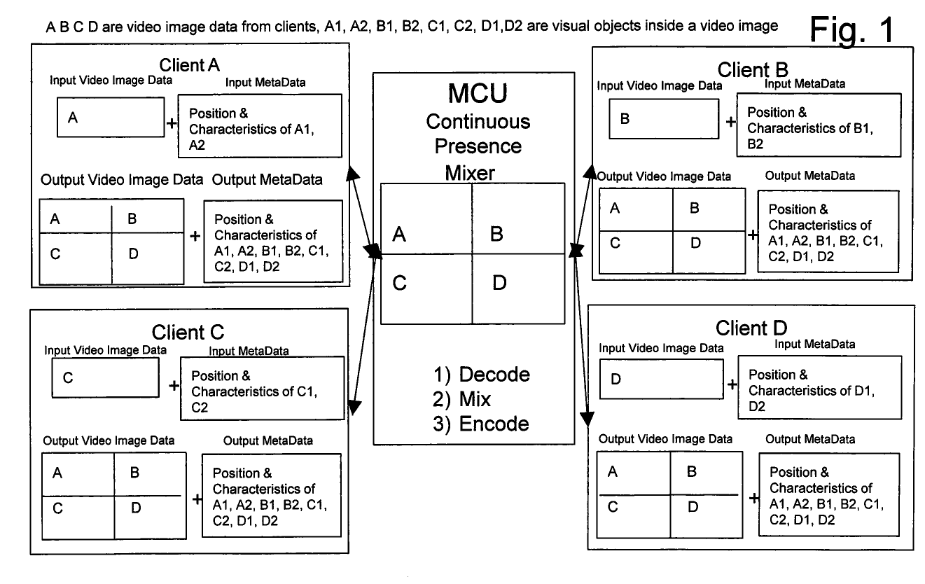

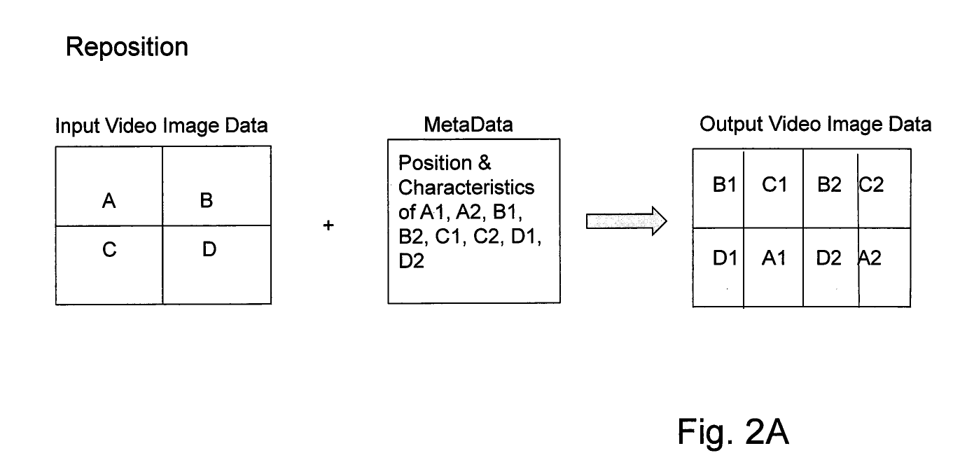

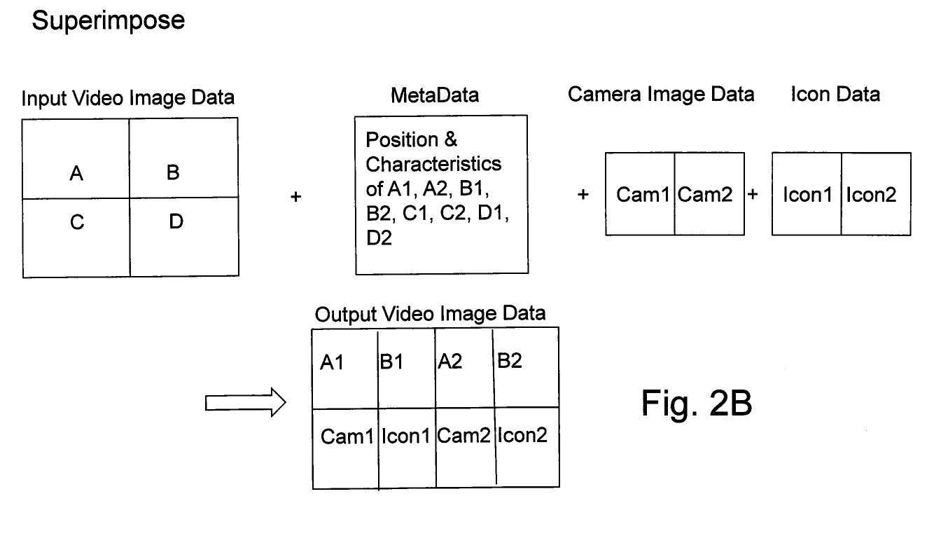

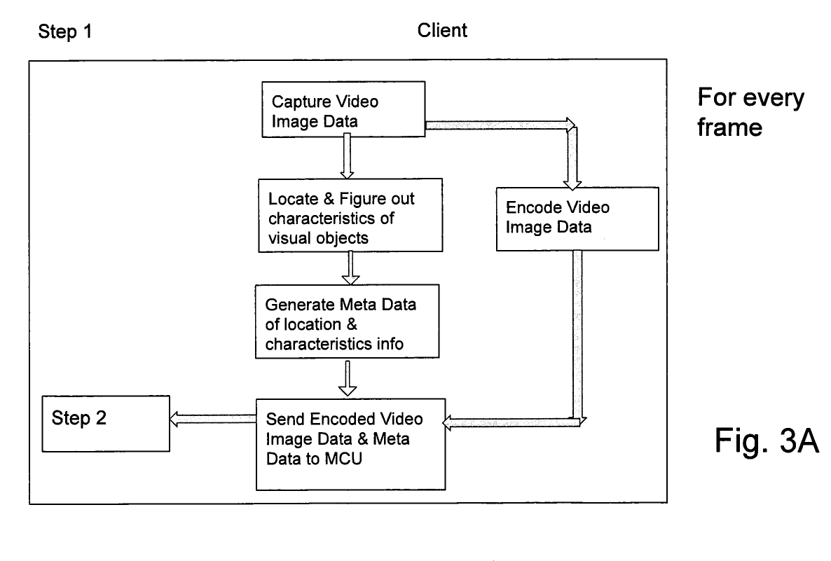

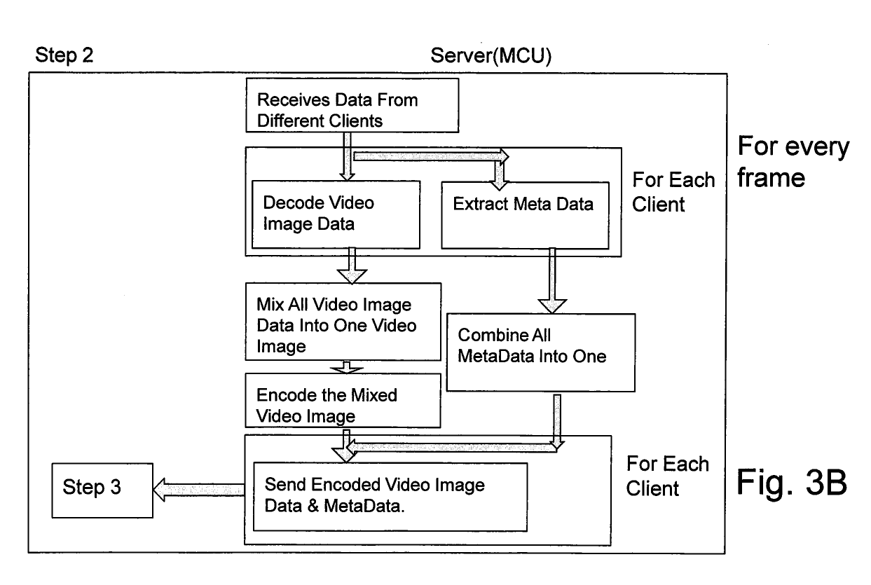

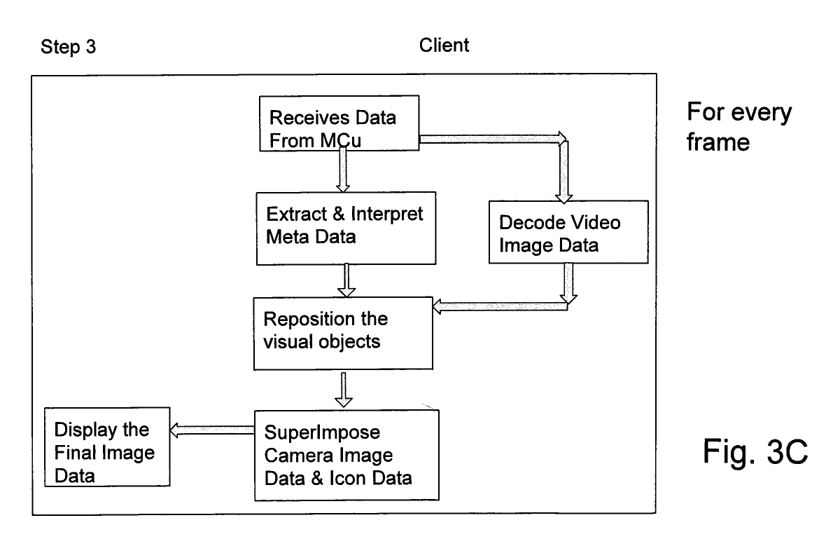

Our current approach is an improvement to the prior MCU technology. The following three steps are performed by the client's devices and the MCU server as that clearly and specifically illustrated in FIGS. 1, 2A, 2B and 3A to 3C,
1. Step 1: On the client side, it captures video image data, encode it, and embeds a meta data with the location info and the characteristics of its own visual objects inside the video image, and sends it to the MCU.
2. Step 2: On the MCU side, video images from different video inputs are decoded, mixed and encoded only once. At the same time, it embeds a meta data with the location info and the characteristics of each video input and its own visual objects on the mixed video image and sends it to the client. In a specific embodiment, the process involves the MCU generating new meta data with the location info and the characteristics of each video input inside the mixed video image, transmits both the newly generated meta-data and all of the clients' input meta-data back to those clients.
3. Step 3: On the client side, it receives the video image data and the meta data. Then it decodes the video image data, parses the meta data to know where each video input's position is and where the visual objects inside the video input is, re-positions and displays them in a flexible way. In addition, it can superimpose its local camera images or special icons at different positions of the result image when needed.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

What is claimed is:

1. A networked communication system comprises:
a multipoint control unit (MCU) operating a MCU server to receive and process multimedia data transmitted from a plurality of networked communication devices functioning as clients of the MCU. The multimedia data transmitted from each of the clients further include meta-data identifying each of the clients transmitting the multimedia data and the MCU server further processes the multimedia data according to the meta-data to position the multimedia data in a plurality of frames for real-time multiple party display for each of the clients.
